(19) United States
(12) Patent Application Publication
(10) Pub. No.: US 2025/0065506 A1
(43) Pub. Date: Feb. 27, 2025

(54) METHOD AND SYSTEM FOR DEXTEROUS MANIPULATION BY A ROBOT

(71) Applicant: Honda Motor Co., Ltd., Tokyo (JP)

(72) Inventors: Changhao WANG, Berkeley, CA (US); Rana SOLTANI ZARRIN, Los Gatos, CA (US)

(21) Appl. No.: 18/414,047

(22) Filed: Jan. 16, 2024

Related U.S. Application Data
(60) Provisional application No. 63/578,036, filed on Aug. 22, 2023.

(51) Int. Cl. B25J 9/16

(52) U.S. Cl. CPC B25J 9/1671; B25J 9/1612; B25J 9/1651

(57) ABSTRACT

A method for dexterous manipulation by a robot includes performing a virtual simulation where a robot model adopts a virtual target position from a virtual initial position, deriving a first policy for maneuvering a robot based on the virtual simulation, performing a first set of real simulations where a first robot adopts a real target position from a real initial position based on the first policy, and deriving a second policy for maneuvering a robot based on sensor data generated in the first set of real simulations. The method also includes combining the first policy and the second policy to derive a third policy for maneuvering a robot. The method also includes causing at least one of the first robot and a second robot to adopt a real target position based on at least one of the third policy and a subsequently derived policy for maneuvering a robot.

### BACKGROUND

Dexterous manipulation is a routine part of operating handheld tools and other objects. In this regard, many handheld tools and objects may be held and operated with a grasp that is different from a grasp used for picking the tool up. Further, other types of handheld tools and objects are otherwise configured for being gripped in a variety of ways to perform work.

To turn a nut using a wrench, for example, a robotic end effector may first pick up the wrench using fingertips and then pull the wrench closer to the palm while transitioning to a power grasp so that a larger force may be applied. As such, it is often useful to change the grasp along with an object pose relative to an end effector between picking up and using the tool (e.g., in-hand manipulation).

Dexterous manipulation skills are often important, for example, in household and factory scenarios, where varieties of tasks call for a variety of handheld tools to perform work. However, there are existing challenges to obtaining robust dexterous manipulation skills in a robotic system.

For example, methods which squarely employ virtual models to learn dexterous manipulation skills are inefficient for real-time computation, often use inaccurate models for emulating real tasks, and are not robust with respect to sensor noise. Furthermore, reinforcement learning methods which squarely employ real simulations are too time consuming to train and have a large sim-to-real gap. Challenges to deploying learned dexterous manipulation skills on the real robot further arise from the sim-to-real gap, imperfect controllers, and noisy sensor measurements.

Consequently, there is demand for robotic systems with improved dexterous manipulation skills. Limitations and disadvantages of conventional and traditional approaches will become apparent to one of skill in the art, through comparison of described systems with some aspects of the present disclosure, as set forth in the remainder of the present application and with reference to the drawings.

### BRIEF DESCRIPTION

According to one aspect, a method for dexterous manipulation by a robot includes performing a virtual simulation where a robot model adopts a virtual target position from a virtual initial position, and deriving a first policy for maneuvering a robot based on the virtual simulation. The method also includes performing a first set of real simulations where a first robot adopts a real target position from a real initial position based on the first policy, and deriving a second policy for maneuvering a robot based on sensor data generated in the first set of real simulations. The method also includes combining the first policy and the second policy to derive a third policy for maneuvering a robot, where action recommendations provided by the first policy and the second policy are added together. The method also includes causing at least one of the first robot and a second robot to adopt a real target position from a real initial position based on at least one of the third policy and a subsequently derived policy for maneuvering a robot.

According to another aspect, a system for dexterous manipulation by a robot includes at least one computer configured to perform a virtual simulation where a robot model adopts a virtual target position from a virtual initial position, and configured to derive a first policy for maneuvering a robot based on the virtual simulation. The system also includes a first robot configured to perform a first set of real simulations where the first robot adopts a real target position from a real initial position based on the first policy. The system also includes a sensor configured to generate sensor data indicating at least one of a position and a pose of the first robot during the first set of real simulations. The at least one computer is configured to derive a second policy for maneuvering a robot based on the sensor data generated in the first set of real simulations, and combine the first policy and the second policy to derive a third policy for maneuvering a robot, where action recommendations provided by the first policy and the second policy are added together. The at least one computer is also configured to cause at least one of the first robot and a second robot to adopt a real target position from a real initial position based on at least one of the third policy and a subsequently derived policy for maneuvering a robot.

According to another aspect, a non-transitory computer readable storage medium storing instructions that, when executed by a computer having a processor, causes the processor to perform a method. The method includes performing a virtual simulation where a robot model adopts a virtual target position from a virtual initial position, and deriving a first policy for maneuvering a robot based on the virtual simulation. The method also includes performing a first set of real simulations where a first robot adopts a real target position from a real initial position based on the first policy, and deriving a second policy for maneuvering a robot based on sensor data generated in the first set of real simulations. The method also includes combining the first policy and the second policy to derive a third policy for maneuvering a robot, where action recommendations provided by the first policy and the second policy are added together. The method also includes causing at least one of the first robot and a second robot to adopt a real target position from a real initial position based on at least one of the third policy and a subsequently derived policy for maneuvering a robot.

### BRIEF DESCRIPTION OF THE DRAWINGS

FIG. 1 is a perspective view of a virtual simulation including a robot model and a virtual object in a virtual initial position.

FIG. 2 is a perspective view of the virtual simulation including the robot model and the virtual object in a virtual intermediate position.

FIG. 3 is a perspective view of the virtual simulation including the robot model and the virtual object in a virtual target position.

FIG. 4 is a perspective view of a test apparatus including a first robot and a real object in a real initial position.

FIG. 5 is a perspective view of the test apparatus including the first robot and the real object in a real intermediate position.

FIG. 6 is a perspective view of the test apparatus including the first robot and the real object in a real target position.

FIG. 7 is a diagram of a learning framework for dexterous manipulation by a robot.

FIG. 8 is an exemplary operating environment of a system for dexterous manipulation by a robot.

FIG. 9 is an exemplary process flow for dexterous manipulation by a robot.

FIG. 10 is an illustration of a computer-readable medium or computer-readable device including processor-executable instructions configured to embody one or more of the provisions set forth herein, according to one aspect.

### DETAILED DESCRIPTION

The systems and methods disclosed herein are configured to obtain dexterous manipulation skills for a robotic system. A virtual simulation is performed using a robot model to generate a first policy for maneuvering a robot, and a first set of real simulations is performed using a first robot operating under the first policy to derive a second policy for maneuvering a robot. The first policy and the second policy are combined into a third policy, which may be deployed to at least one of the first robot and a second robot to perform work. In an embodiment, a second set of real simulations is performed using the first robot operating under the third policy to derive a fourth policy for maneuvering a robot, which may be deployed to at least one of the first robot and the second robot to perform work.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also interconnect with components inside a device using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, connected thermometer, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), among others.

Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE, CAT-M, LoRa), satellite, dedicated short range communication (DSRC), among others.

“Communication interface” as used herein may include input and/or output devices for receiving input and/or devices for outputting data. The input and/or output may be for controlling different features, components, and systems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device or mobility device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms. The processor may also include any number of modules for performing instructions, tasks, or executables.

“User” as used herein may be a biological being, such as humans (e.g., adults, children, infants, etc.).

A “wearable computing device,” as used herein can include, but is not limited to, a computing device component (e.g., a processor) with circuitry that can be worn or attached to user. In other words, a wearable computing device is a computer that is subsumed into the personal space of a user. Wearable computing devices can include a display and can include various sensors for sensing and determining various parameters of a user. For example, location, motion, and physiological parameters, among others. Exemplary wearable computing devices can include, but are not limited to, watches, glasses, clothing, gloves, hats, shirts, jewelry, rings, earrings necklaces, armbands, leashes, collars, shoes, earbuds, headphones and personal wellness devices.

### System Overview

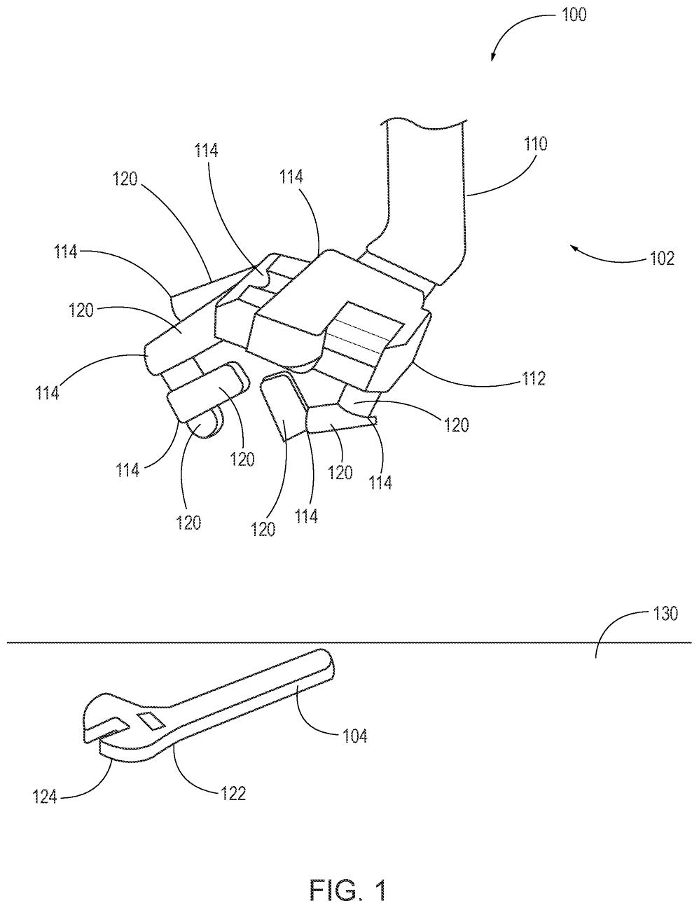

Referring now to the drawings, the drawings are for purposes of illustrating one or more exemplary embodiments and not for purposes of limiting the same. FIGS. 1-3 depict a virtual simulation 100 including a robot model 102 and a virtual object 104, where the robot model 102 adopts a virtual target position from a virtual initial position.

The robot model 102 includes a robotic arm 110 connected with a robotic hand 112 configured for grabbing the virtual object 104. In this manner, the robot model 102 simulates an end effector capable of manipulating the virtual object 104 in the virtual simulation 100.

The robotic arm 110 and the robotic hand 112 are each formed from rotating joints 114 and rigid connecting portions 120 having interrelated positions and orientations in a virtual space which enable maneuvering the robot model 102 for grabbing and manipulating the virtual object 104. While, in the depicted embodiment, the robot model 102 includes the robotic arm 110 and the robotic hand 112 as an end effector, the robot model 102 may alternatively or additionally include various types of end effectors capable of manipulating the virtual object 104 without departing from the scope of the present disclosure.

The virtual object 104 includes a handle 122 extended from a tool end portion 124. The handle 122 is elongated and configured for being grabbed by the robot model 102, where the robotic hand 112 picks up the handle 122, and repositions the handle 122 for operating the virtual object 104. While, in the depicted embodiment, the virtual object 104 is a wrench and the tool end portion 124 is a wrench head, the virtual object 104 may alternatively or additionally include a variety of handheld items, tools, and devices without departing from the scope of the present disclosure. In this regard, the virtual object 104 may be kitchen equipment such as a spatula, a spoon, and a knife, machining equipment such as a hammer, a saw, and a drill, and assembly components such as nuts, bolts, and screws. Further, while in the depicted embodiment the virtual object 104 includes the handle 122, the virtual object 104 may alternatively lack a handle, and be manipulated directly by the robot model 102 without departing from the scope of the present disclosure.

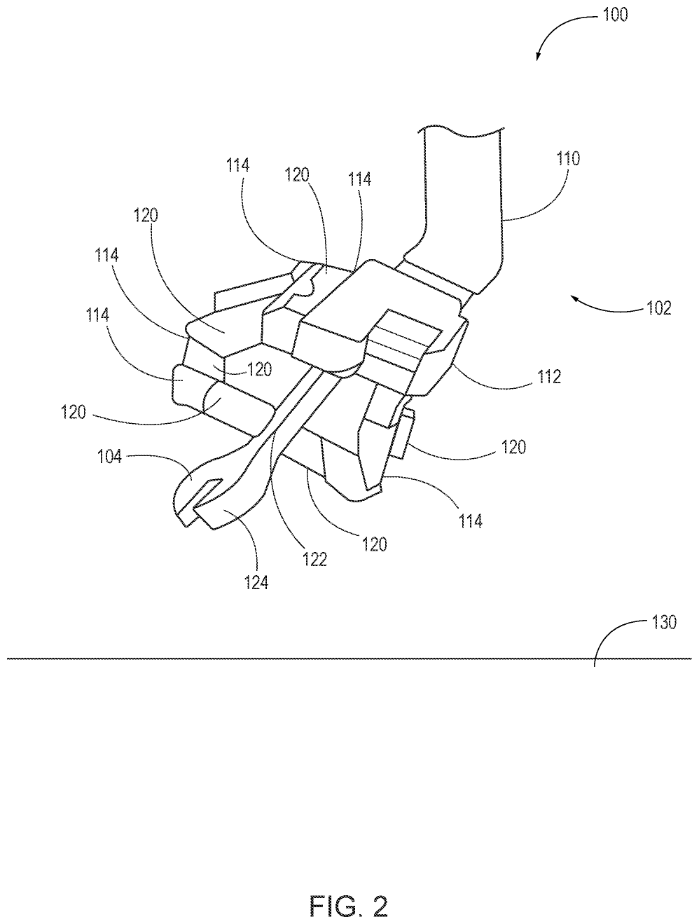

FIG. 1 depicts the robot model 102 in the virtual initial position, where the robot model 102 is located above the virtual object 104, and the virtual object 104 is at rest on a virtual floor 130. FIG. 2 depicts the robot model 102 in a virtual intermediate position, where the robotic hand 112 is grabbing the handle 122 in a first position corresponding to picking the virtual object 104 off the virtual floor 130.

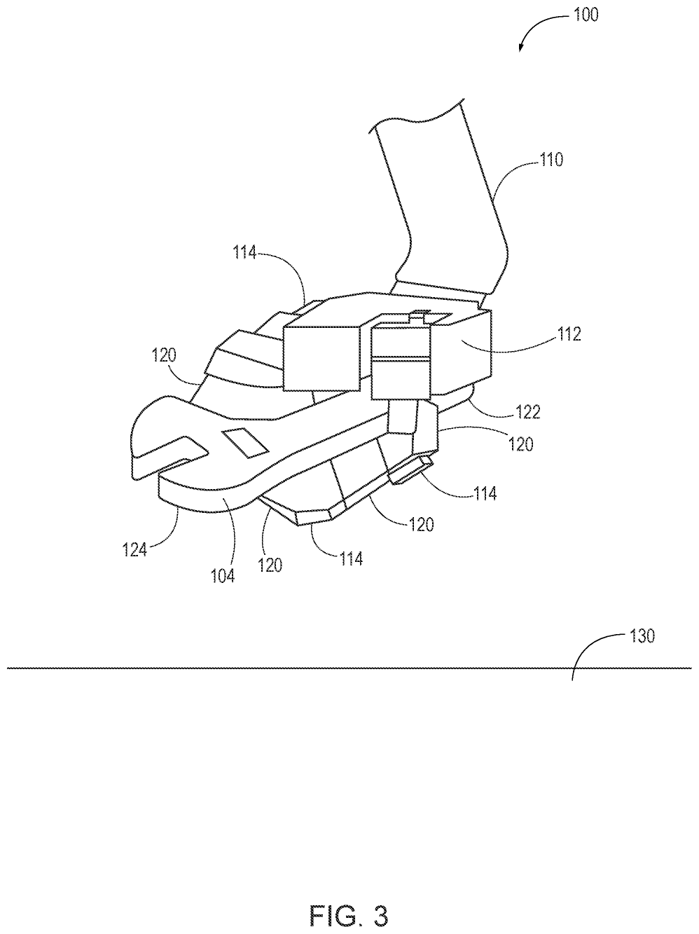

FIG. 3 depicts the robot model 102 in the virtual target position, where the robotic hand 112 is grabbing the handle 122 in a second position for operating the virtual object 104. Notably, a pose and a position of the handle 122 changes relative to a pose and a position of the robot model 102 as the virtual object 104 moves from the first position toward the second position.

In an embodiment, the virtual simulation 100 begins with the robotic hand 112 grabbing the virtual object 114 in a virtual initial position as shown in FIG. 2. In such an embodiment, both the virtual initial position and the virtual target position of the robot model 102 include grabbing the virtual object 104. With this construction, a policy of maneuvering a robot generated based on the virtual simulation 100 is relatively focused toward operating the virtual object 104, thereby improving an efficacy of the virtual simulation 100 and policy output without requiring additional computational resources.

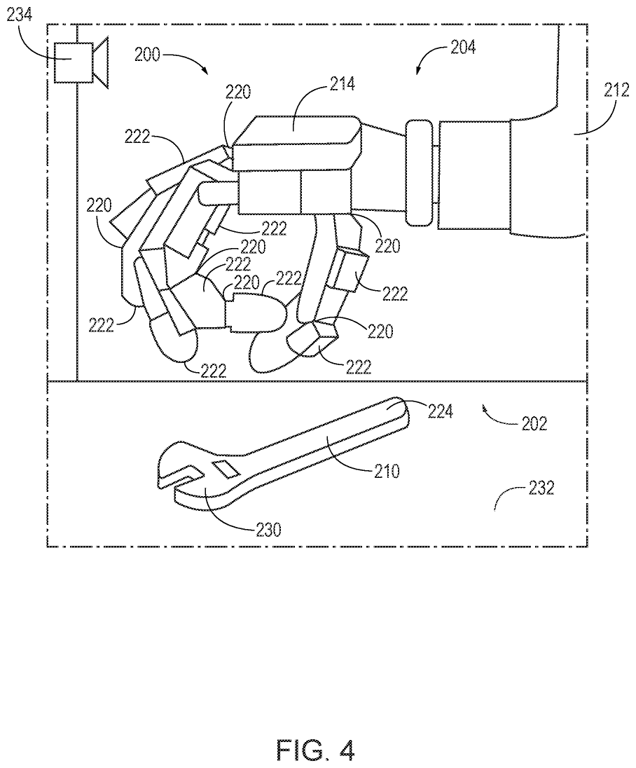

FIGS. 4-6 depict a first set of real simulations 200 performed with a test apparatus 202 including a first robot 204 and a real object 210, where the first robot 204 adopts a real target position from a real initial position. The virtual simulation 100 corresponds to the first set of real simulations 200, where the robot model 102 simulates the first robot 204, and the virtual object 104 simulates the real object 210.

The first robot 204 includes a robotic arm 212 connected with a robotic hand 214 configured for grabbing the real object 210. In this manner, the first robot 204 is an end effector capable of manipulating the real object 210 in the first set of real simulations 200.

The robotic arm 212 and the robotic hand 214 are each formed from rotating joints 220 and rigid connecting portions 222 having interrelated positions and orientations in a virtual space which enable maneuvering the first robot 204 for grabbing and manipulating the object 104. While, in the depicted embodiment, the first robot 204 includes the robotic arm 212 and the robotic hand 214 as an end effector, the first robot 204 may alternatively or additionally include various types of end effectors capable of grabbing and manipulating the real object 210 without departing from the scope of the present disclosure.

The real object 210 includes a handle 224 extended from a tool end portion 230. The handle 224 is elongated and configured for being grabbed by the first robot 204, where the robotic hand 214 picks up the handle 224, and repositions the handle 224 for operating the real object 210. While, in the depicted embodiment, the real object 210 is a wrench and the tool end portion 230 is a wrench head, the real object 210 may alternatively or additionally include a variety of handheld items, tools, and devices without departing from the scope of the present disclosure. In this regard, the real object 210 may be kitchen equipment such as a spatula, a spoon, and a knife, machining equipment such as a hammer, a saw, and a drill, and assembly components such as nuts, bolts, and screws. Further, while in the depicted embodiment the real object 210 includes the handle 224, the real object 210 may alternatively lack a handle, and be manipulated directly by the first robot 204 without departing from the scope of the present disclosure.

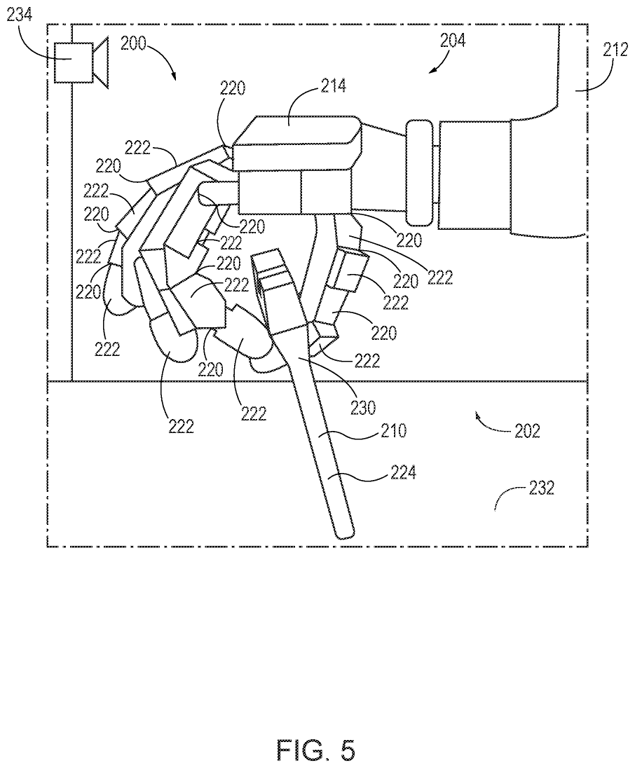

FIG. 4 depicts the first robot 204 in the real initial position, where the first robot 204 is located above the real object 210, and the real object 210 is at rest on a floor 232. FIG. 5 depicts the first robot 204 in a real intermediate position, where the robotic hand 214 is grabbing the handle 224 in a first position corresponding to picking the real object 210 off the floor 232.

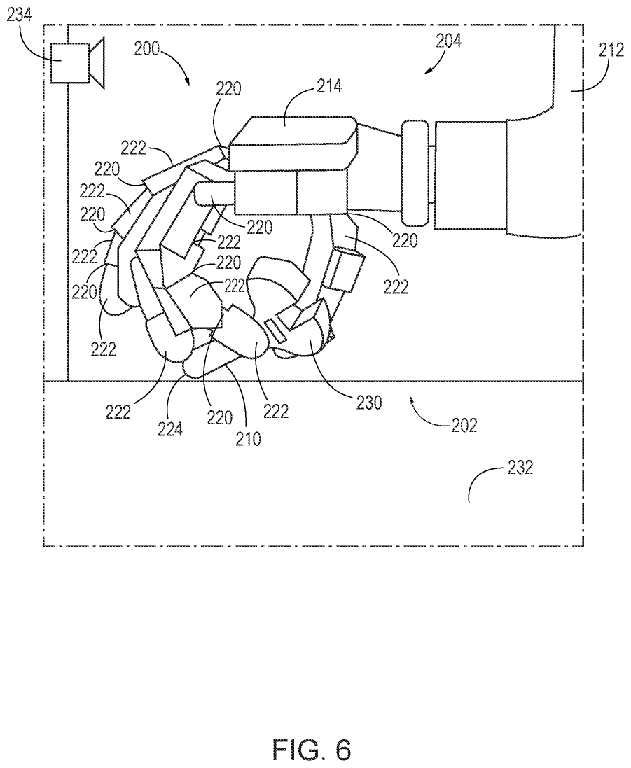

FIG. 6 depicts the first robot 204 in the real target position, where the robotic hand 214 is grabbing the handle 224 in a second position for operating the real object 210. Notably, a pose and a position of the handle 224 changes relative to a pose and a position of the first robot 204 as the real object 210 moves from the first position toward the second position.

In an embodiment, the first set of real simulations 200 begins with the robotic hand 214 grabbing the real object 210 in a real initial position as shown in FIG. 5. In such an embodiment, both the initial real position and the real target position of the first robot 204 include grabbing the real object 210. With this construction, a policy of maneuvering a robot derived based on the first set of real simulations 200 is relatively focused toward operating the real object 210, thereby improving an efficacy of the first set of real simulations 200 without requiring additional computational resources.

The first set of real simulations 200 includes a sensor 234 configured to generate sensor data of the first robot 102 and the real object 104. The sensor data indicates a position and a pose of the first robot 102 and the real object 104 during the first set of real simulations 200.

As depicted, the sensor 234 is a camera configured to capture image data as the sensor data indicating the positions and the orientations of the joints 220, the connecting portions 222, and the real object 104 in the first set of real simulations 200. While, as depicted, the sensor 234 is a camera, the sensor 234 may additionally or alternatively include a variety of sensors including potentiometers, encoders, transformers, Hall effect sensors, Eddy current sensors, piezoelectric sensors, and other sensors configured to generate data indicating the positions and orientations of the first robot 102 and the real object 104 in the first set of real simulations 200 without departing from the scope of the present disclosure.

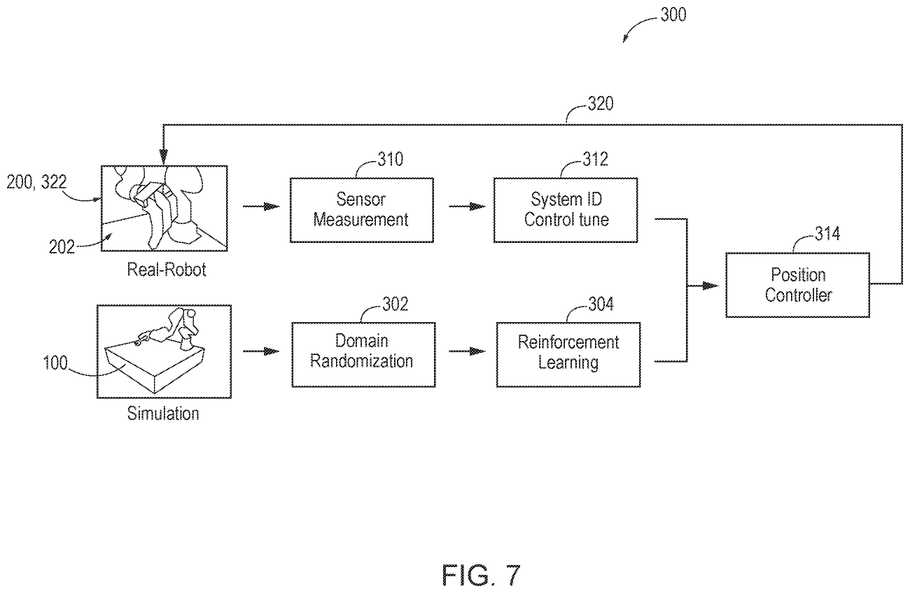

FIG. 7 depicts a learning framework 300 for dexterous manipulation by a robot operating a tool. The learning framework 300 incorporates the virtual simulation 100, the first set of real simulations 200, and the real simulation 200 to derive a policy for maneuvering a robot.

As shown in FIG. 7, the virtual simulation 100 is executed with domain randomization provided at a randomization module 302, where initial values for a pose and a position of the robot model 102 and the virtual object 104 are randomized. More specifically, positions and orientations of the joints 114 and the connecting portions 120 in the robotic hand 112, and a position and an orientation of the virtual object 104 relative to the robotic hand 112 are assigned random values in the virtual initial position.

At reinforcement learning module 304, a machine learning algorithm receives virtual data from the virtual simulation 100 to perform reinforcement learning and derive a first policy for maneuvering a robot based on the virtual data. The virtual data includes the positions and the orientations of the joints 114 and the connecting portions 120 in the robotic hand 112, and the position and the orientation of the virtual object 104 in the virtual simulation 100. The virtual data additionally includes the virtual initial position and the virtual target position of the robot model 102 and the virtual object 104. In this manner, the machine learning algorithm is configured to derive the first policy based on the positions and orientations of the joints 114, the connecting portions 120, and the virtual object 104 with respect to the virtual initial position and the virtual target position of the robot model 102 and the virtual object 104.

The machine learning algorithm may include a Markov decision learning process that incorporates a state space, an action space, a reward function, a state-transition probability, and a discount factor. For each time step in the virtual simulation 100, a state agent executes an action and receives a scalar reward, and the machine learning algorithm develops a policy which maximizes an expected future return of the reward.

In an embodiment, the machine learning algorithm is configured to derive the first policy based on virtual data including pose data and position data of the virtual object 104 as the robot model 102 moves from the initial virtual position toward the virtual target position in the virtual simulation 100. In a further embodiment, the machine learning algorithm is configured to derive the first policy based on the pose data and position data of the virtual object 104 relative to pose data and position data of the robot model 102 in the virtual simulation 100.

The virtual simulation 100 is executed repeatedly through the randomization module 302 for a plurality of iterations with domain randomization, where the machine learning algorithm receives the virtual data of each iterations at the reinforcement learning module 304. The machine learning algorithm is configured to derive the first policy over the plurality of iterations, and the virtual initial position of the robot model 102 is randomized over the plurality of iterations. In this manner, the first policy produced by the machine learning algorithm is robust as compared to a policy derived from a consistent initial position in the virtual simulation 100.

Noise may be added to the virtual data indicating the positions and orientations of the joints 114, the connecting portions 120, and the virtual object 104. More specifically, noise may be added to pose data and position data of the virtual object 104 in the virtual simulation 100, where the machine learning algorithm derives the first policy based on the pose data and the position data of the virtual object 104 with the added noise. In an embodiment, 10 degrees of noise is added to the pose data of the virtual object 104 to simulate noise from the sensor data generated in the first set of real simulations 200 indicating an orientation of the real object 210. Noise may additionally or alternatively be added to pose data and position data of the virtual object 104 and the robot model 102, including positions and orientations of the joints 114 and the connecting portions 120, where the machine learning algorithm derives the first policy based on the pose data and the position data of the robot model 102 with the added noise. In this manner, the first policy produced by the machine learning algorithm is robust to sensor noise in a real world environment of a robot, such as the first robot 204 in the first simulation 200, as compared to a policy derived from virtual data that is consistently recorded.

With continued reference to FIG. 7, the first policy is deployed to the first robot 204 in the first set of real simulations 200, and the first robot 204 manipulates the real object 210 in the first set of real simulations 200 based on the first policy. At a sensor measurement module 310 of the learning framework 300, the sensor 234 generates the sensor data of the first robot 204 and the real object 210 in the first set of real simulations 200. In an embodiment, the first set of real simulations 200 is executed repeatedly through a policy module 312 for a plurality of iterations, where the machine learning algorithm receives the sensor data generated in each iteration at the sensor measurement module 310. In a further embodiment, the real initial position of the first robot 204 is randomized over the plurality of iterations of the first set of real simulations 200.

At the policy module 312, a machine learning algorithm is configured to derive a second policy that is a residual policy for maneuvering a robot based on the sensor data of the first robot 204 and the real object 210 in the first set of real simulations 200. In this manner, the second policy is derived from updating the first policy based on results of the first set of real simulations 200. In an embodiment, the second policy is derived based on a norm of a pose by the first robot 204 to the real target position. The machine learning algorithm configured to derive the second policy based on the sensor data may be the same machine learning algorithm configured to derive the first policy based on the virtual data. With the real initial position of the first robot 204 randomized over the plurality of iterations of the first set of real simulations 200, the second policy produced by the machine learning algorithm is robust as compared to a policy derived from a consistent real initial position in the first set of real simulations 200.

A position controller 314 combines the first policy and the second policy to derive a third policy for maneuvering a robot, where action recommendations provided by the first policy and the second policy are added together. As indicated by an arrow 320, the position controller deploys the third policy to the first robot 204 in a second set of real simulations 322, causing the first robot 204 and the real object 210 to move from the real initial position to the real target position based on the third policy. While, as depicted, the second set of real simulations 322 is performed using test apparatus 202 including the first robot 204, the third policy may be deployed to another test apparatus including a robot having similar features and functioning in a similar manner as the first robot 204 manipulating the real object 210 without departing from the scope of the present disclosure.

At the policy module 312, the machine learning algorithm is configured to derive a fourth policy as a residual policy for maneuvering a robot based on the sensor data of the first robot 204 and the real object 210 in the second set of real simulations 322. In this regard, the machine learning algorithm processes the sensor data from the sensor measurement module 310 indicating the pose and the position of the first robot 204 and the real object 210 in the set of real simulations 322 to produce the fourth policy.

In an embodiment, the second set of real simulations 322 is executed repeatedly with the policy module 312 for a plurality of iterations, where the machine learning algorithm receives the sensor data generated in each iteration at the sensor measurement module 310. In a further embodiment, the real initial position of the first robot 204 is randomized over the plurality of iterations of the second set of real simulations 322, thereby generalizing the fourth policy toward a real world application for a robot and an object having random or otherwise uncontrolled initial positions.

In this manner, the fourth policy is derived from updating the third policy based on results of the second set of real simulations 322. With this construction the machine learning algorithm refines the combination of the first policy, which is determined based on virtual data, and the second policy, which is determined based on sensor data, toward a real world application performed by the first robot 204.

In an embodiment, the fourth policy is derived based on a norm of a pose by the first robot 204 to the real target position in the second set of real simulations 322. The machine learning algorithm configured to derive the fourth policy based on the sensor data may be the same machine learning algorithm configured to derive the second policy based on the sensor data, and the first policy based on the virtual data. With the real initial position of the first robot 204 randomized over the plurality of iterations of the second set of real simulations 322, the fourth policy produced by the machine learning algorithm is robust as compared to a policy derived from a consistent initial position in the second set of real simulations 322.

Notably, the learning framework 300 enables successive rounds of policy development that may incorporate both virtual data and sensor data from successive virtual simulations and real simulations. In this regard, successive virtual simulations may be conducted using a residual policy most recently developed by the policy module 312. The reinforcement learning module 304 processes the successive virtual simulations and develops a successive policy in a manner similar to the first policy. The position controller 314 is configured to combine the successive policy with the most recently developed residual policy in a manner similar to producing the third policy. The combined policy may be deployed from the position controller 314 to the test apparatus 202 for successive real simulation and development of a successive residual policy for maneuvering a robot in a manner similar to deriving the fourth policy at the policy module 312.

As such, the learning framework 300 may perform policy development in a manner which continuously incorporates data generated from successive rounds of virtual simulations and real simulations. With this construction, the learning framework 300 is configured to continuously refine residual policies incorporating virtual data and sensor data to a desired efficacy in the first robot 204.

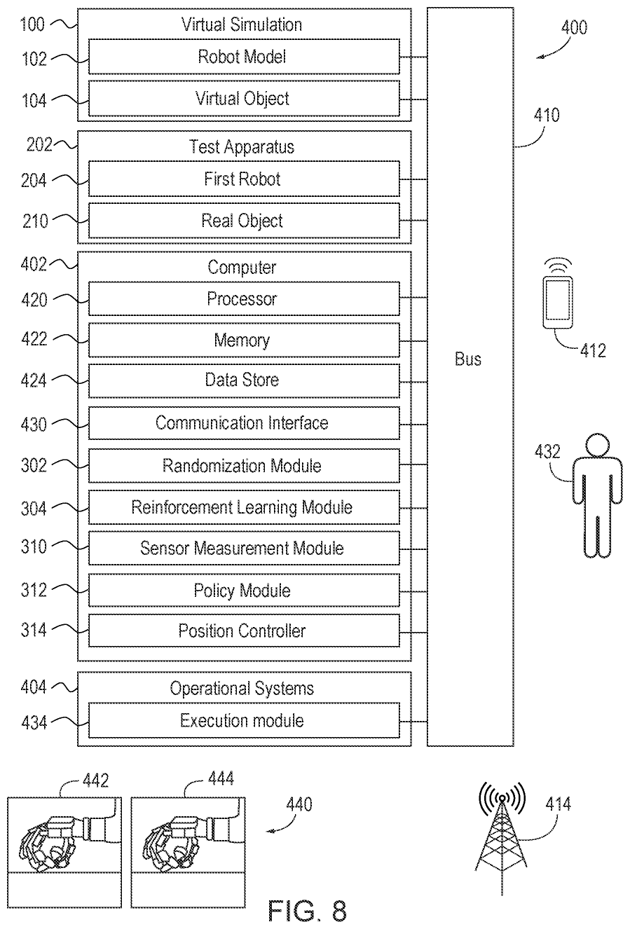

FIG. 8 is an exemplary component diagram of an operating environment 400 for dexterous manipulation by a robot, according to one aspect. The operating environment includes the test apparatus 202, a computer 402, and operational systems 404. The test apparatus 202, the computer 402, and the operational systems 404 may be interconnected by a bus 410. The components of the operating environment 400, as well as the components of other systems, hardware architectures, and software architectures discussed herein, may be combined, omitted, or organized into different architectures for various embodiments. The computer 402 may be implemented with a device or remotely stored.

The computer 402 may be configured to execute the virtual simulation 100, implemented as a part of the test apparatus 202, and support elements of the learning framework 300. The computer 402 may be implemented as part of a telematics unit or an electronic control unit among other potential aspects of the test apparatus 202. In other embodiments, the components and functions of the computer 402 can be implemented with other devices such as a portable device 412, database, remote server, or another device connected via a network (e.g., a network 414).

The computer 402 may be capable of providing wired or wireless computer communications utilizing various protocols to send and receive electronic signals internally to and from components of the operating environment 400. Additionally, the computer 402 may be operably connected for internal computer communication via the bus 410 (e.g., a Controller Area Network (CAN) or a Local Interconnect Network (LIN) protocol bus) to facilitate data input and output between the computer 402 and the components of the operating environment 400.

The computer 402 includes a processor 420, a memory 422, a data store 424, and a communication interface 430, which are each operably connected for computer communication via the bus 410 and/or other wired and wireless technologies. The communication interface 430 provides software and hardware to facilitate data input and output between the components of the computer 402 and other components, networks, and data sources, which will be described herein.

The computer 402 is also operably connected for computer communication (e.g., via the bus 410 and/or the communication interface 430) to one or more operational systems 404. The operational systems 404 can include, but are not limited to, any automatic or manual systems that can be used to enhance the test apparatus 202, and facilitate operation of the test apparatus 202 by a user 432. The operational systems 404 include an execution module 434. The execution module 434 monitors, analyzes, and/or operates the test apparatus 202, to some degree. For example, the execution module 434 may store, calculate, and provide information about the test apparatus 202, such as previous usage statistics, including sensor data from previous use.

The operational systems 404 also include and/or are operably connected for computer communication to the test apparatus 202. For example, one or more sensors including the sensor 234 of the test apparatus 202 may be incorporated with the execution module 434 to monitor characteristics of the test apparatus 202 such as the pose and the position of the first robot 204, the real object 210, the floor 232 and other aspects of the test apparatus 202. In another embodiment, the test apparatus 202 may communicate with one or more devices or services (e.g., a wearable computing device, non-wearable computing device, cloud service, etc.) to perform simulations including the first set of real simulations 200 and the second set of real simulations 322.

The test apparatus 202, the computer device 402, and/or the operational systems 404 are also operatively connected for computer communication to and via the network 414. The network 414 is, for example, a data network, the Internet, a wide area network (WAN) or a local area (LAN) network. The network 414 serves as a communication medium to various remote devices (e.g., databases, web servers, remote servers, application servers, intermediary servers, client machines, or other portable devices).

With continued reference to FIG. 8, the operating environment 400 includes a plurality of robots 440 which include similar features and function in a similar manner as the first robot 204 with respect to manipulating an object. While, as depicted, the plurality of robots 440 includes a second robot 442 and a third robot 444, the plurality of robots 440 may include more or fewer robots similar to the first robot 204 without departing from the scope of the present disclosure.

Each robot in the plurality of robots 440 is configured to receive and execute a policy derived by the computer 402 for maneuvering the robot in a real world application. In this regard, the computer 402 is configured to deploy at least one of the third policy, the fourth policy, and any subsequent policy developed in the learning framework 300 to at least one robot in the plurality of robots 440 for real world applications in manipulating objects.

The computer 402 may additionally or alternatively deploy at least one of the third policy, the fourth policy, and any subsequent policy to the portable device 412 for the user 432 to direct a robot guided by the deployed policy. While, as depicted, the portable device 412 is a handheld computing device including a display with a graphic user interface for enabling the user 432 to provide instructions for directing a robot, the portable device 412 may additionally or alternatively include a wearable computing device corresponding to a robot.

For example, the portable device 412 may include a data glove or a robotic glove worn by the user 432. With this construction, the data glove or the robotic glove correspond to a robotic hand configured for receiving instruction from the user 432, aided by the deployed policy.

As such, the operating environment 400 facilitates improved dexterous manipulation performance by a robot through developing and deploying a policy for maneuvering the robot that incorporates virtual data from a virtual simulation and sensor data from a real simulation. Detailed embodiments describing exemplary methods using the system and network configuration discussed above will now be discussed in detail.

### II. Methods for Dextrous Manipulation by a Robot

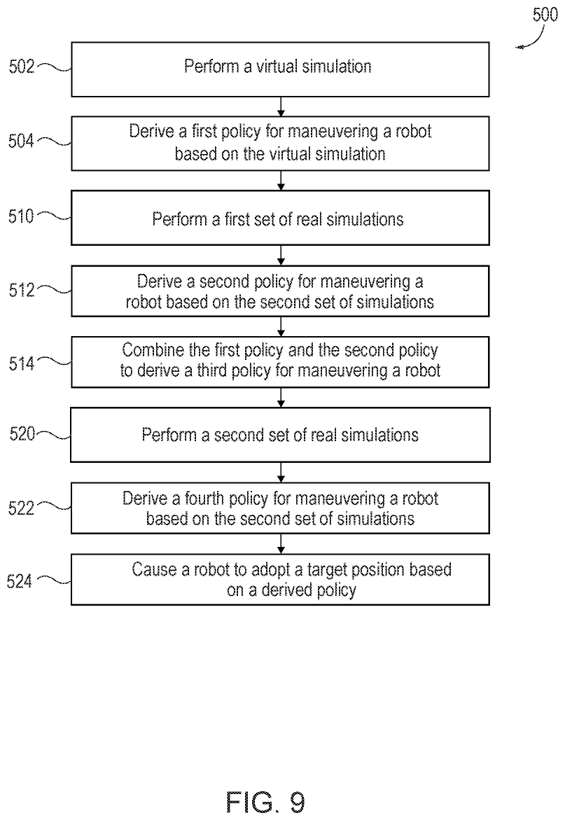

Referring to FIG. 9, a method 500 for dexterous manipulation by a robot will be described according to an exemplary embodiment. FIG. 9 will be described with reference to FIGS. 1-8. For simplicity, the method 500 will be described as a sequence of blocks, but the elements of the method 500 can be organized into different architectures, elements, stages, and/or processes.

At block 502, the method includes performing the virtual simulation 100, where the robot model 102 adopts the virtual target position from the virtual initial position. At least one of the virtual initial position and the virtual target position of the virtual simulation 100 includes the robot model 102 grabbing the virtual object 104.

In an embodiment, each of the virtual initial position and the virtual target position include the robot model 102 grabbing the virtual object 104. With this construction, a policy of maneuvering a robot based on the first set of real simulations 200 is relatively focused toward operating the real object 210, thereby improving an efficacy of the first set of real simulations 200 without requiring additional computational resources.

The robot model 102 includes the robotic arm 110 connected with the robotic hand 112 as an end effector, and the virtual object 104 includes the handle 122. The at least one of the virtual initial position and the virtual target position in the virtual simulation 100 includes the robotic hand 112 grabbing the virtual object 104 by the handle 122.

At block 504, the method includes deriving a first policy for maneuvering a robot based on the virtual simulation 100. In this regard, the computer 402 derives the first policy based on virtual data including pose data and position data of the virtual object as the robot model 102 moves from the virtual initial position toward the virtual target position in the virtual simulation 100. In an embodiment, the computer 402 derives the first policy based on the pose data and the position data of the virtual object relative to pose data and position data of the robot model 102 in the virtual simulation.

The virtual simulation 100 is executed repeatedly, for a plurality of iterations, and the machine learning algorithm is configured to derive the first policy over the plurality of iterations. In this regard, the method 500 includes repeatedly performing the virtual simulation 100 at block 502 for a plurality of iterations, where deriving the first policy includes processing virtual data generated from each iteration in the plurality of iterations with the machine learning algorithm at block 504.

The machine learning algorithm employs a smoothness reward corresponding to an acceleration value of a portion of the robot model 102 in the virtual simulation 100. In this manner, the machine learning algorithm is configured to produce a policy which limits acceleration of a robot and an object manipulated by the robot, thereby reducing a tendency of the robot to drop the object.

The method 500 includes adding noise to the pose data and the position data of the virtual object 104, where the first policy is derived at block 504 based on the pose data and the position data of the virtual object 104 with the added noise. Noise may additionally or alternatively be added to pose data and position data of the robot model 102, including positions and orientations of the joints 114 and the connecting portions 120, where the machine learning algorithm derives the first policy based on the pose data and the position data of the robot model 102 with the added noise. With this construction, the first policy produced by the machine learning algorithm is robust to sensor noise in a real world environment of a robot, such as the first robot 204 in the first simulation 200, as compared to a policy derived from virtual data that is consistently recorded.

The virtual initial position of the robot model 102 is randomized over the plurality of iterations. As such, the machine learning algorithm develops the first policy for real world applications where a robot, such as the first robot 204, begins a movement toward a target position from an uncontrolled initial position.

The method further includes 500 randomizing aspects of virtual data describing the robot model 102 and the virtual object 104 at multiple time steps in the virtual simulation 100. More specifically, the method 500 includes randomizing at least one of a pose of the virtual object 104, a contact force between the virtual object 104 and the robot model 102, a mass of the virtual object 104, a center of mass of the object 104, and an amount of friction between the virtual object 104 and the robot model 102 is randomized at multiple time steps in the virtual simulation 100. In this regard, 10 degrees of noise may be added to the pose data of the virtual object 104 at each of the multiple time steps. In an embodiment, the method includes randomizing aspects of virtual data describing the robot model 102 and the virtual object 104 at each time step in the virtual simulation 100.

At block 510, the method 500 includes performing the first set of real simulations 200, where the first robot 204 adopts the real target position from the real initial position based on the first policy. The virtual target position in the virtual simulation 100 disposes the robot model 102 and the virtual object 104 in a same orientation and configuration as the real target position of the first robot 204 and the real object 210 in the first set of real simulations 200. As such, the virtual simulation 100 is configured to produce a policy that is relatively focused toward specific actions such as picking up and operating a hand tool, as compared to a policy developed based on moving the robot model 102 and the virtual object 104 toward a distinct or otherwise unrelated target position.

In a manner corresponding to the virtual simulation 100, at least one of the real initial position and the real target position of the real simulation 200 includes the first robot 204 grabbing the real object 210. In this regard, the first robot 204 includes the robotic arm 212 connected with the robotic hand 214 as an end effector, and the real object 210 includes the handle 224, where at least one of the real initial position and the real target position of the first set of real simulations 200 includes the robotic hand 214 grabbing the real object 210 by the handle 224.

In an embodiment, the real initial position includes the robotic hand 214 grabbing the handle 224 in a first position as depicted in FIG. 2, and the real target position includes the robotic hand 214 grabbing the handle 224 in a second position as depicted in FIG. 3. As shown between FIGS. 2 and 3, the pose and the position of the real object 210 changes relative to the pose and the position of the robotic hand 214 as the real object 210 moves from the first position toward the second position.

At block 512, the method 500 includes deriving a second policy for maneuvering a robot based on the sensor data of the first robot 204 and the real object 210 in the first set of real simulations 200. The computer 402 processes the sensor data from the first set of real simulations 200 with the machine learning algorithm, where the first robot 204 executes the first policy. In this manner, the second policy is derived from updating the first policy based on results of the first set of real simulations 200. In an embodiment, the results of the first set of simulations 200 indicate a norm of a pose by the first robot 204 and the real object 210 to the real target position, and the computer 402 derives the second policy based on the norm of the pose by the first robot 204.

As such, the computer 402 derives the second policy based on sensor data indicating the pose and the position of the real object 210 as the first robot 204 moves from the real initial position toward the real target position in the first set of real simulations 200. More specifically, the computer 402 derives the second policy based on sensor data indicating at least one of the pose and the position of the real object 210 relative to the pose and the position of the first robot 204 in the first set of real simulations 200.

At block 514, the method 500 includes combining the first policy and the second policy to derive the third policy for maneuvering a robot. In this regard, the position controller 314 combines the first policy and the second policy such that action recommendations provided by the first policy and the second policy are added together.

At block 520, the method 500 includes performing the second set of real simulations 322 where the first robot 204 adopts the real target position from the real initial position based on the third policy. At block 522, the method 500 includes deriving a fourth policy for maneuvering a robot based on the sensor data generated in the second set of real simulations 322. In this manner, the fourth policy is derived from updating the third policy based on results of the second set of real simulations 322.

Notably, the learning framework 300 and operating environment 400 employed by the method 500 enable successive rounds of policy development that may incorporate both virtual data and sensor data from successive virtual simulations and real simulations. In this regard, successive virtual simulation similar to the virtual simulation 100 may be conducted using a residual policy most recently developed by the machine learning algorithm at the policy module 312. The reinforcement learning module 304 processes the successive virtual simulations and develops a successive policy in a manner similar to the first policy. The position controller 314 is configured to combine the successive policy with the most recently developed residual policy in a manner similar to producing the third policy. The combined policy may be deployed from the position controller 314 to the test apparatus 202 for successive real simulation and development of a successive residual policy for maneuvering a robot in a manner similar to deriving the fourth policy at the policy module 312.

As such, the method 500 may used to perform policy development in a manner which continuously incorporates data generated from successive rounds of virtual simulations and real simulations. With this construction, after deriving the fourth policy, the method 500 is configured to subsequently derive refined residual policies incorporating additional virtual data and sensor data from successive rounds of virtual simulation and real simulation.

At block 524, the method 500 includes causing at least one of the first robot 204 and a robot in the plurality of robots 440 to adopt a real target position from a real initial position based on at least one of the third policy and a subsequently derived policy for maneuvering a robot. In this regard, the computer 402 may deploy a policy to the first robot 204 for further simulation, deploy a policy to at least one of the second robot 442 and the third robot 444 for a real world application, and deploy a policy to the portable device 412 for actuation by the user 432.

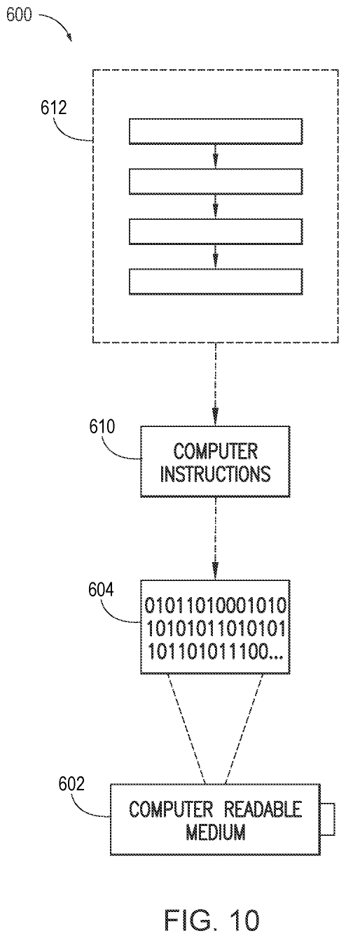

Still another aspect involves a non-transitory computer-readable medium including processor-executable instructions configured to implement one aspect of the techniques presented herein. An aspect of a computer-readable medium or a computer-readable device devised in these ways is illustrated in FIG. 10, where an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 610 configured to operate according to one or more of the principles set forth herein. In this implementation 600, the processor-executable computer instructions 610 may be configured to perform a method 612, such as the method 500 of FIG. 9. In another aspect, the processor-executable computer instructions 610 may be configured to implement a system, such as the operating environment 400 of FIG. 8. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that varieties of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for dexterous manipulation by a robot, the method comprising:
performing a virtual simulation wherein a robot model adopts a virtual target position from a virtual initial position, and deriving a first policy for maneuvering a robot based on the virtual simulation;
performing a first set of real simulations wherein a first robot adopts a real target position from a real initial position based on the first policy, and deriving a second policy for maneuvering a robot based on sensor data generated in the first set of real simulations;
combining the first policy and the second policy to derive a third policy for maneuvering a robot, wherein action recommendations provided by the first policy and the second policy are added together; and
causing at least one of the first robot and a second robot to adopt a real target position from a real initial position based on at least one of the third policy and a subsequently derived policy for maneuvering a robot.

2. The method of claim 1, further comprising performing a second set of real simulations wherein the first robot adopts a real target position from a real initial position based on the third policy, and deriving a fourth policy for maneuvering a robot based on sensor data generated in the second set of real simulations.

3. The method of claim 1, wherein the virtual target position in the virtual simulation disposes the robot model in a same orientation and configuration as the real target position of the first robot in the first set of real simulations.

4. The method of claim 1, further comprising repeatedly performing the virtual simulation for a plurality of iterations, wherein deriving the first policy includes processing virtual data generated from the plurality of iterations with a machine learning algorithm.

5. The method of claim 4, wherein the machine learning algorithm employs a smoothness reward corresponding to an acceleration value of a portion of the robot model.

6. The method of claim 4, wherein the virtual initial position of the robot model is randomized over the plurality of iterations.

7. The method of claim 1, further comprising recording pose data of a virtual object in the virtual simulation, and deriving the first policy based on the pose data, wherein at least one of a pose of the virtual object, a contact force between the virtual object and the robot model, a mass of the virtual object, a center of mass of the object, and an amount of friction between the virtual object and the robot model is randomized at multiple time steps in the virtual simulation.

8. The method of claim 1, wherein at least one of the virtual initial position and the virtual target position include the robot model grabbing a virtual object, and the method further comprises deriving the first policy based on at least one of pose data and position data of the virtual object as the robot model moves from the virtual initial position toward the virtual target position in the virtual simulation.

9. The method of claim 1, wherein at least one of the real initial position and the real target position include the first robot grabbing a real object, and the method further comprises deriving the second policy based on sensor data indicating at least one of a pose and a position of the real object as the first robot moves from the real initial position toward the real target position in the first set of real simulations.

10. The method of claim 9, further comprising deriving the first policy based on at least one of the pose data and the position data of the virtual object relative to at least one of pose data and position data of the robot model in the virtual simulation; and
deriving the second policy based on sensor data indicating at least one of the pose and the position of the real object relative to at least one of a pose and a position of the first robot in the first set of real simulations.

11. The method of claim 9, wherein the first robot includes a robotic arm connected with a robotic hand, and the real object includes a handle, wherein the at least one of the real initial position and the real target position of the first set of real simulations includes the robotic hand grabbing the real object by the handle.

12. The method of claim 11, wherein the real initial position includes the robotic hand grabbing the handle in a first position, and the real target position includes the robotic hand grabbing the handle in a second position, wherein at least one of the pose and the position of the real object changes relative to the pose and the position of the robotic hand as the real object moves from the first position toward the second position.

13. The method of claim 9, further comprising adding noise to the at least one of pose data and position data of the virtual object, wherein the first policy is derived based on the at least one of pose data and position data of the virtual object with the added noise.

14. The method of claim 1, further comprising recording pose data of a virtual object in the virtual simulation, adding noise to the pose data, and deriving the first policy based on the pose data with the added noise.

15. A system for dexterous manipulation by a robot, the system comprising:
at least one computer configured to perform a virtual simulation wherein a robot model adopts a virtual target position from a virtual initial position, and configured to derive a first policy for maneuvering a robot based on the virtual simulation;
a first robot configured to perform a first set of real simulations wherein the first robot adopts a real target position from a real initial position based on the first policy; and
a sensor configured to generate sensor data indicating at least one of a position and a pose of the first robot during the first set of real simulations,
wherein the at least one computer is configured to:
derive a second policy for maneuvering a robot based on the sensor data generated in the first set of real simulations,
combine the first policy and the second policy to derive a third policy for maneuvering a robot, wherein action recommendations provided by the first policy and the second policy are added together, and
cause at least one of the first robot and a second robot to adopt a real target position from a real initial position based on at least one of the third policy and a subsequently derived policy for maneuvering a robot.

16. The system of claim 15, wherein at least one of the virtual initial position and the virtual target position in the virtual simulation includes the robot model grabbing a virtual object, and at least one of the real initial position and the real target position in the real simulation includes the first robot grabbing a real object, wherein the at least one computer is configured to:
derive the first policy based on at least one of pose data and position data of the virtual object as the robot model moves from the virtual initial position toward the virtual target position in the virtual simulation; and
derive the second policy based on sensor data indicating at least one of a pose and a position of the real object as the first robot moves from the real initial position toward the real target position in the first set of real simulations.

17. The system of claim 16, wherein the robot model includes a robotic arm connected with a robotic hand, the virtual object includes a handle, and the at least one of the virtual initial position and the virtual target position in the virtual simulation includes the robotic hand grabbing the virtual object by the handle,
wherein the first robot includes a robotic arm connected with a robotic hand, the real object includes a handle, and the at least one of the real initial position and the real target position in the real simulation includes the robotic hand grabbing the real object by the handle.

18. The system of claim 17, wherein the handle of the virtual object is elongated and each of the virtual initial position and the virtual target position in the virtual simulation includes the robotic hand grabbing the handle, wherein the robotic hand moves along a length of the handle, and rotates a grip on the handle when the robot model moves from the virtual initial position to the virtual target position, and
wherein the handle of the real object is elongated and each of the real initial position and the real target position in the real simulation includes the robotic hand grabbing the handle, wherein the robotic hand moves along a length of the handle, and rotates a grip on the handle when the first robot moves from the real initial position to the real target position.

19. The system of claim 16, wherein the sensor is a camera configured to generate image data indicating the at least one of the pose and the position of the first robot, and indicating at least one of a pose and a position of the real object during the first set of real simulations.

20. A non-transitory computer readable storage medium storing instructions that, when executed by a computer having a processor, causes the processor to perform a method, the method comprising:
performing a virtual simulation wherein a robot model adopts a virtual target position from a virtual initial position, and deriving a first policy for maneuvering a robot based on the virtual simulation;
performing a first set of real simulations wherein a first robot adopts a real target position from a real initial position based on the first policy, and deriving a second policy for maneuvering a robot based on sensor data generated in the first set of real simulations;
combining the first policy and the second policy to derive a third policy for maneuvering a robot, wherein action recommendations provided by the first policy and the second policy are added together; and
causing at least one of the first robot and a second robot to adopt a real target position from a real initial position based on at least one of the third policy and a subsequently derived policy for maneuvering a robot.
